(19) United States
(12) Patent Application Publication
(10) Pub. No.: US 2018/0192017 A1
(43) Pub. Date: Jul. 5, 2018

(54) APPARATUS AND METHODS FOR DETECTION AND EVALUATION OF FAILURES IN A DISPLAY SYSTEM

(71) Applicants: BARCO N.V., Kortrijk (BE); BARCO INC., Rancho Cordova, CA (US)

(72) Inventors: Stefan VANDEMAELE, Mariakerke (BE); Alexander GOCKE, Rancho Cordova, CA (US)

(73) Assignees: BARCO N.V., Kortrijk (BE); BARCO INC., Rancho Cordova, CA (US)

(21) Appl. No.: 15/395,894

(22) Filed: Dec. 30, 2016

(51) Int. Cl. H04N 9/31; G06T 7/00

(52) U.S. Cl. CPC H04N 9/3194; G06T 2207/20224; G06T 7/0002

(57) ABSTRACT

A method and system for carrying out the following steps: In a first step of a method a first image or picture of a display system is captured when the system is operating nominally. In a second step, a second image or picture of the display system is taken. In a third step, the first and second images or pictures are compared and differences between first and second images pictures are evaluated to detect problems or failures of the display system.

The present invention relates to apparatus and methods for detection and evaluation of failures in a display system, e.g. a multiscreen display system, as well as software to carry out such methods.

### DISCUSSION OF THE PRIOR ART

U.S. Pat. No. 7,657,402 “System and method for remotely monitoring, diagnosing, intervening with and reporting problems with cinematic equipment” describes a method of communicating with, and receiving data representative of equipment state and status from presentation components in theatres. Sensors may be used to monitor each attribute of each piece of equipment. Data is collected from each sensor and transferred to a central location that facilitates analysis. Different failures are detected by different sensors.

In U.S. Pat. No. 6,424,998 “System permitting the display of video or still image content on selected displays of an electronic display network according to customer dictates” verification that images are displayed as ordered is facilitated by an information storage module or, more preferably, by a digital camera or series of digital cameras. U.S. Pat. No. 6,424,998 does not offer solutions to detect and evaluate different types of failures of a display system with the cameras used to monitor the image content.

The art needs improvement.

### SUMMARY OF THE INVENTION

What is needed is an apparatus and methods to detect and evaluate different types of failures of a display system with no or as little possible modifications of the display system being monitored and with as little number of different sensors as possible.

If such a system and methods that will allow detection of faults and failures in a projection display with a minimum of modifications to said projection display can be produced then these systems should be able to detect different types of failures yet rely on the same hardware.

A purpose of the present invention is to provide apparatus and methods which contributes to the art of detecting and evaluating failures in a projection display system.

Such a projection display system comprises at least first and second projection screens. A first or main projector projects images on the first projection screen. The second projection screen can move from a first position to a second position. In the first position, the second projection screen does not overlap the first projection screen. In the second position, the second projection screen overlaps the first projection screen.

In a first step of a method according to embodiments the present invention, a first image or picture of the display system is captured when the system is operating nominally, e.g. as determined by a technician operating the display system. Nominally means for instance that the second projection screen overlaps the first projection screen. The first image or picture is stored for later use. The first image or picture can for instance be a grayscale picture. The first image or picture is a reference image or picture of a display system operating as expected, without visible failure.

In a second step, a second image or picture of the display system is taken. The second image or picture can be taken in absence of the technician, e.g. just before a theatrical presentation that requires the first and second projection screens to be positioned correctly. The second image or picture can for instance be a grayscale picture. The first and second images pictures need not necessarily encompass the entire display system but they have to contain the images of the regions of the display system where failure is be detected.

In a third step, the first and second images or pictures are compared and differences between first and second images pictures are evaluated to detect problems or failures of the display system.

It is an advantage of this method that a single image capturing device can be used to detect different problems and failures.

In a further aspect of the inventions, the lighting conditions in the projection room are evaluated. It is an advantage of this aspect of the present invention that the brightness of captured images or pictures can be corrected to make a comparison between images or pictures less dependent on fluctuations in the lighting conditions. Alternatively, the second image or picture is taken only when the lighting conditions are adequate or the same as for the first image or picture (as evaluated e.g. by a photometer or metadata relevant to and distributed with the images being projected).

In a further aspect of the invention, comparing the first and second images or pictures involves subtracting the pixel values in the second image or picture from the pixel values in the first image or picture. The result of the subtraction is a difference image, i.e. of the differences between the first image and the second image. Relevant differences can be emphasized, for example by thresholding. Alternatively, it is the pixel values of the first image that are subtracted from the pixel values of the second image

In a further aspect of the present invention, a neural network is used for comparison of the first picture and the second picture and for determining the differences. The difference may be detected using the neural network by thresholding.

In a further aspect of the present invention the first image or picture is an image or picture of a different display system than the display system which will be monitored. It is an advantage of that aspect of the present invention that the first image or picture can be generated off-site, without disturbing normal operation of a display system such as the Barco Escape™ display system (a multi-screen display system).

The first image or picture can be a digital image of a similar but not necessarily identical display system. The first image or picture can for instance be generated by a 3D digital model.

In a further aspect of the present invention, significant differences between the first image or picture and the second image or picture are reported electronically to a supervisory function, e.g. to a maintenance crew. For instance, data processing means can generate an alarm and send a message via a communication network to signal a failure.

An apparatus according to an embodiment of the present invention can comprise an image capturing device to capture first and second images of a multi-screen display system, a data storage to store at least one of the first and second images or pictures of the display system and data processing means to compare the first and second images or pictures and to detect problems and/or failures of the display system. The field of view of the image capturing device preferably encompasses at least part of two screens of the multi-screen display system.

In a further aspect of the present invention, means are provided to evaluate the lighting conditions when an image or picture of the display system is taken. For example, a photometer can be provided to measure the lighting conditions from which results an evaluation of the lighting conditions can be made when an image or picture of the display system is taken.

In a further aspect of the invention, the image capturing device and/or the means for evaluating the lighting conditions such as a photometer can be an integral part of a projector for projecting images on at least one screen of the multi-screen display.

Another aspect the present invention provides a computer program product for executing any of the method of the present invention when executed on a processor.

Another aspect the present invention provides a non-transitory signal storage medium storing the computer program product.

### BRIEF DESCRIPTION OF THE DRAWINGS

FIG. 1 shows an example of multi-screen display system like a Barco Escape™ display system.

FIG. 2A shows a top view of a Barco Escape™ display system when lateral screens are in their first position distanced away from the central screen.

FIG. 2B shows a top view of a Barco Escape™ display system when the lateral screens are in their second position overlapping the central screen.

FIG. 3 shows a perspective view of a Barco Escape™ display system.

FIG. 4 shows a perspective view of a mechanism to move a lateral screen from a first position to a second position and vice-versa.

FIG. 5 shows a top view of a mechanism to move a lateral screen from a first position to a second position and vice-versa.

FIG. 6 shows a perspective view of an Escape™ display system with masks used to hide part of the main screen.

FIG. 7 shows a perspective view of an Escape™ display system with projectors held to the ceiling by means of scissor mounts.

FIG. 8 shows a perspective view of an Escape™ display system with multiple failures.

FIG. 9 shows an example of test pattern that can be used to detect and evaluate failure of a projector that projects images on a lateral screen.

FIG. 10 shows a perspective view of an Escape™ display system without failure and ready to be photographed to generate a first image or picture (or reference image or picture).

FIG. 11A shows an example of the result of a subtraction between a first image or picture (corresponding to FIG. 10) and a second image or picture (corresponding to a failure of the upper and ow lower masks as seen on FIG. 8).

FIG. 11B shows an example of the result of a thresholding operation executed on the image represented on FIG. 11A.

FIG. 12 shows an example of the result of a subtraction between a first image or picture (corresponding to FIG. 10) and a second image or picture (corresponding to a failure of deployment system for the lateral screen 1003 on FIG. 10).

FIG. 13 shows an example of the result of a subtraction between a first image or picture (corresponding to figure the display system of FIG. 10) and a second image or picture (corresponding to a failure of the curtain withdrawal system).

FIG. 14A shows an example of the result of a subtraction between a first image or picture (corresponding to figure the display system of FIG. 10) and a second image or picture (corresponding to a failure of the deployment system for the projector projecting images on the lateral screen 1002). FIG. 14B shows a further example of test pattern that can be used to detect and evaluate failure of a projector that projects images on a lateral screen.

FIG. 15 shows a sequence of steps according to the invention to detect and evaluate failures of the display system.

FIG. 16 shows another sequence of steps according to a method of the present invention.

### DEFINITIONS

Nominal. Being according to plan.

Pixel Value.

In photography and computing, a grayscale or greyscale digital image is an image in which the value of each pixel is a single sample, that is, it carries only intensity information. Images of this sort, also known as black-and-white, are composed exclusively of shades of gray, varying from black at the weakest intensity to white at the strongest.

In computing, although the grayscale can be computed through rational numbers, image pixels are stored in binary, quantized form. Some early grayscale monitors can only show up to sixteen (4-bit) different shades, but nowadays grayscale images (as photographs) intended for visual display (both on screen and printed) are commonly stored with 8 bits per sampled pixel, which allows 256 different intensities (i.e., shades of gray) to be recorded, typically on a non-linear scale. The precision provided by this format is barely sufficient to avoid visible banding artifacts, but is very convenient for programming because a single pixel then occupies a single byte.

Each of the pixels that represents an image stored inside a computer has a pixel value which describes how bright that pixel is, and/or what color it should be. For grayscale images, the pixel value is a single number that represents the brightness of the pixel. The most common pixel format is the byte image, where this number is stored as an 8-bit integer giving a range of possible values from 0 to 255. Typically zero is taken to be black, and 255 is taken to be white. Values in between make up the different shades of gray.

To represent color images, separate red, green and blue components must be specified for each pixel (assuming an RGB colorspace), and so the pixel ‘value’ is actually a vector of three numbers. Often the three different components are stored as three separate ‘monochromatic images known as color planes (one for each of red, green and blue), which have to be recombined when displaying a complete image or processing such an image.

Multi-spectral images can contain even more than three components for each pixel, and by extension these are stored in the same kind of way, as a vector pixel value, or as separate color planes.

The actual grayscale or color component intensities for each pixel need not actually be stored explicitly. Often, all that is stored for each pixel is an index into a colormap in which the actual intensity or colors can be looked up.

Although simple 8-bit integers or vectors of 8-bit integers are the most common sorts of pixel values used, some image formats support different types of value, for instance 32-bit signed integers or floating point values. Such values are extremely useful in image processing as they allow processing to be carried out on the image where the resulting pixel values are not necessarily 8-bit integers. If this approach is used then it is usually necessary to set up a colormap which relates particular ranges of pixel values to particular displayed colors.

Technician. A human operator who able to operate a display system and in particular an Escape display system and evaluate whether or not the display system operates correctly. It also include a robot, computer system, artificial intelligence or any system that can accomplish some or all of the tasks that would be executed by a human operator to operate a display system.

Thresholding. The simplest thresholding methods replace each pixel in an image with a black pixel if the image intensity is less than some fixed constant T (that is, Iᵢⱼ<T), or a white pixel if the image intensity is greater than that constant. In the example image on the right, this results in the dark tree becoming completely black, and the white snow becoming completely white.

### DETAILED DESCRIPTION OF THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The present invention applies in particular to a Barco Escape™ display system.

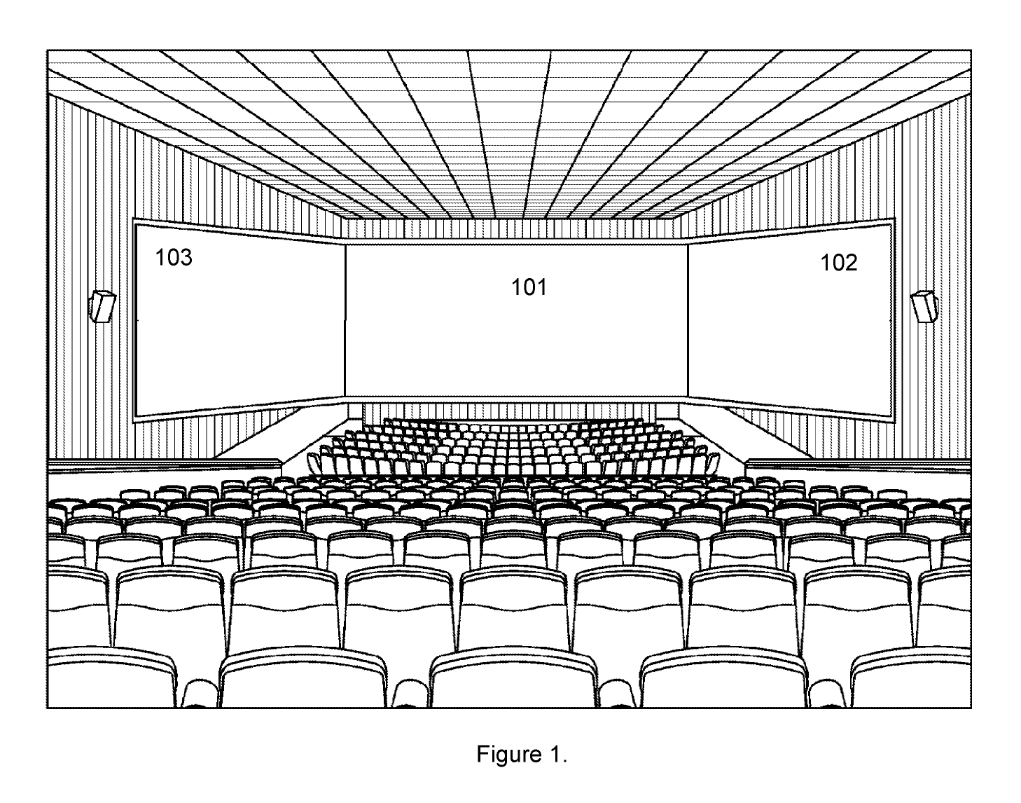

FIG. 1 shows a perspective view of a Barco Escape™ display system. A central front projection screen (also known as main screen) 101 is flanked by a first lateral front projection screen 102 on the right and a second lateral front projection screen 103 on the left.

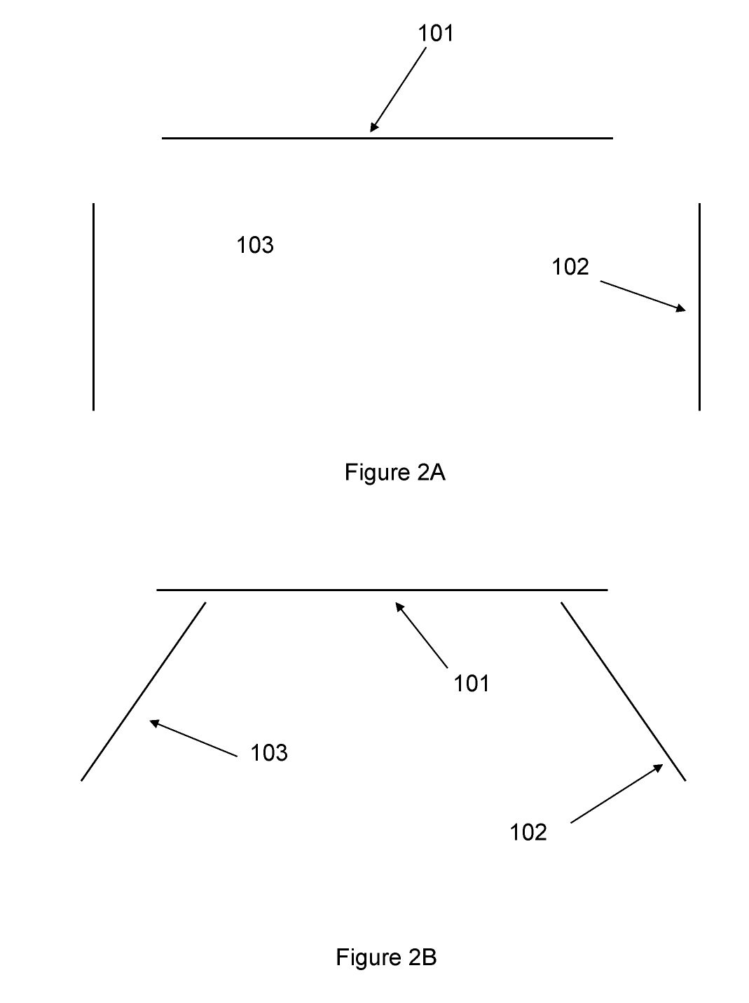

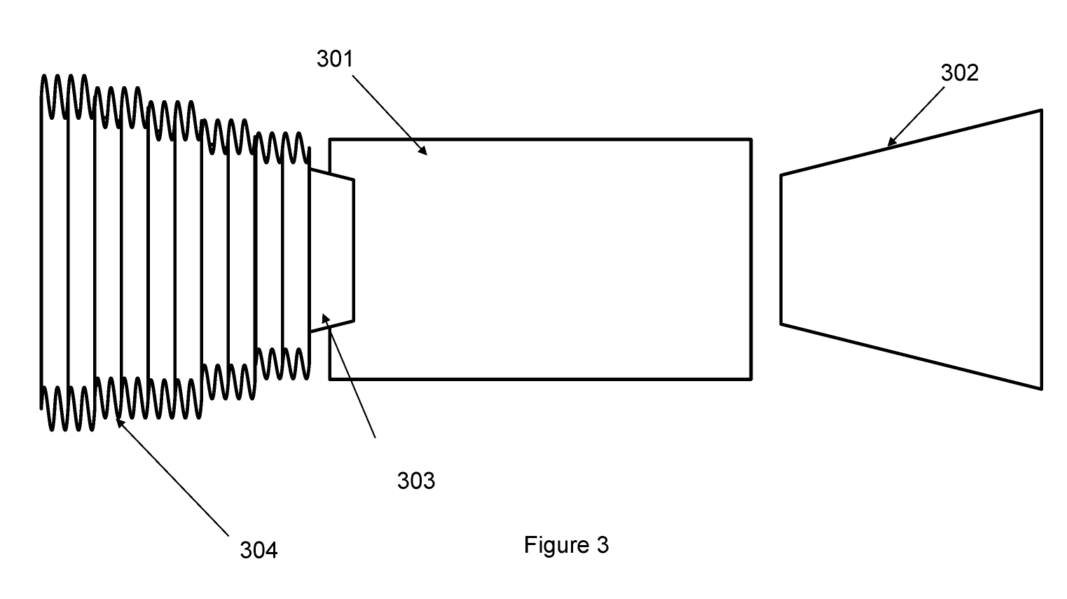

The lateral screens 102 and 103 can move or be moved between a first position (as seen on FIG. 2A) and a second position (as seen on FIG. 2B).

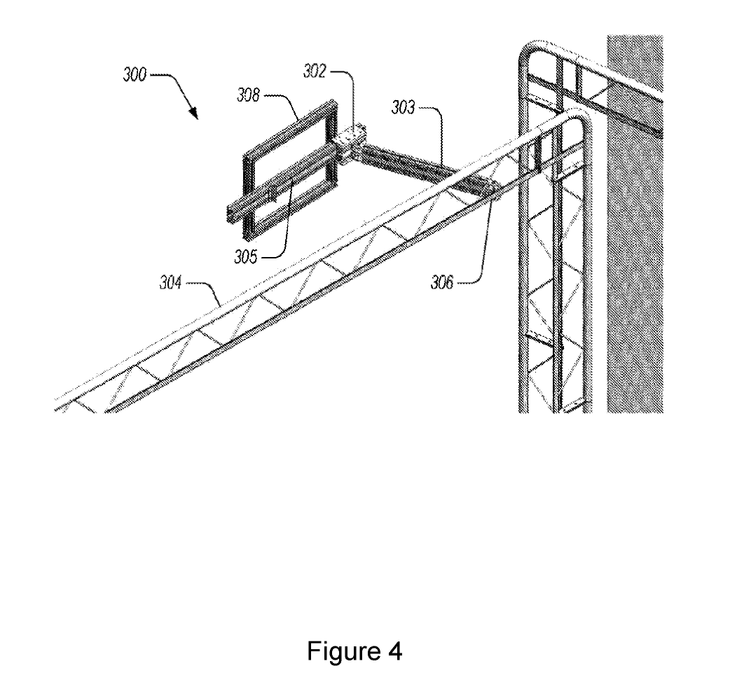

The lateral screens can be hidden by curtains as illustrated on FIG. 3. On FIG. 3, the lateral screen 302 on the left side of the main screen 301 is hidden by a curtain 304.

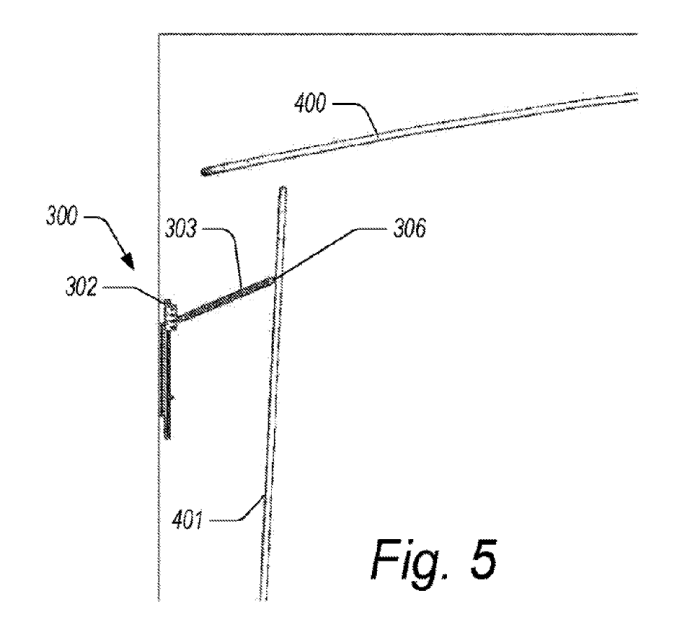

FIG. 4 illustrates an example of mechanism that can be used to move a lateral screen from a first position to a second position and back.

FIG. 4 is an illustration of an example screen bracket in a medially (towards the mid line of the theater) extended position. Bracket 300 has a base 308 for connection to a structure, such as a theater wall, beam, truss, bar, rod, pole, plank, plate, screen, another frame, and/or any architectural and/or structural piece of a venue. Arm 303 connects base 308 to frame 304 using joint 306. First arm 303 is connected to second arm 305 using joint 302.

Joints 306 and 302 may be hinges that allows arms 303 and 305, respectively, to swing with angular motion. Joints 306 and 302 may also be joints that allow arms 303 and 305, respectively, to swing and/or slide in multiple directions, including left, right, back, forward, up, down, roll, pitch, and yaw, and/or any combination of those directions. Joints 306 and 302 may also be coupled to one or more actuators that facilitate the movement of the joints.

Joints 306 and 302 may be controlled independently and/or be configured to move screens in different ways. For example, joint 306 may enable fine changes to the angle of a screen, such as by elongation or shortening along the longitudinal axis of arm 303. Joint 302 may comprise a bracket that is movable along a track or arm 305, such that it can advance the screen in a forward or rear direction.

In an alternate construction, joint 306 is a pivotable joint and rearward movement of joint 302 such as by rearward movement along the track or arm 305 will retract joint 306 and associated screen in a lateral direction.

Arms 303 and 305 may comprise any of a variety of tracks trusses, beams, bars, poles, telescopic rods, hydraulic jacks, prismatic joints, pneumatic cylinders, screws, springs, electrical motors and/or any support structure known in the art. In some embodiments, the length of arms 303 and 305 may be adjusted by rotational movement of 2 components (e.g., threaded engagement), turning, telescopic pulling, pushing, bending, and/or any other means of manipulation. Arms 303 and 305 may be coupled to actuators that can make the adjustments.

Base 308 may also comprise any of a variety of trusses, bars, beams, poles, plates, chassis, and/or other support structure known in the art, depending upon whether base 308 is intended to be secured to a wall, free standing support, or other structure.

Frame 304 may be connected to and/or house a viewing screen. Frame 304 may comprise trusses, beams, bars, rods, poles, and/or other support structure and/or housing known in the art for supporting a viewing screen.

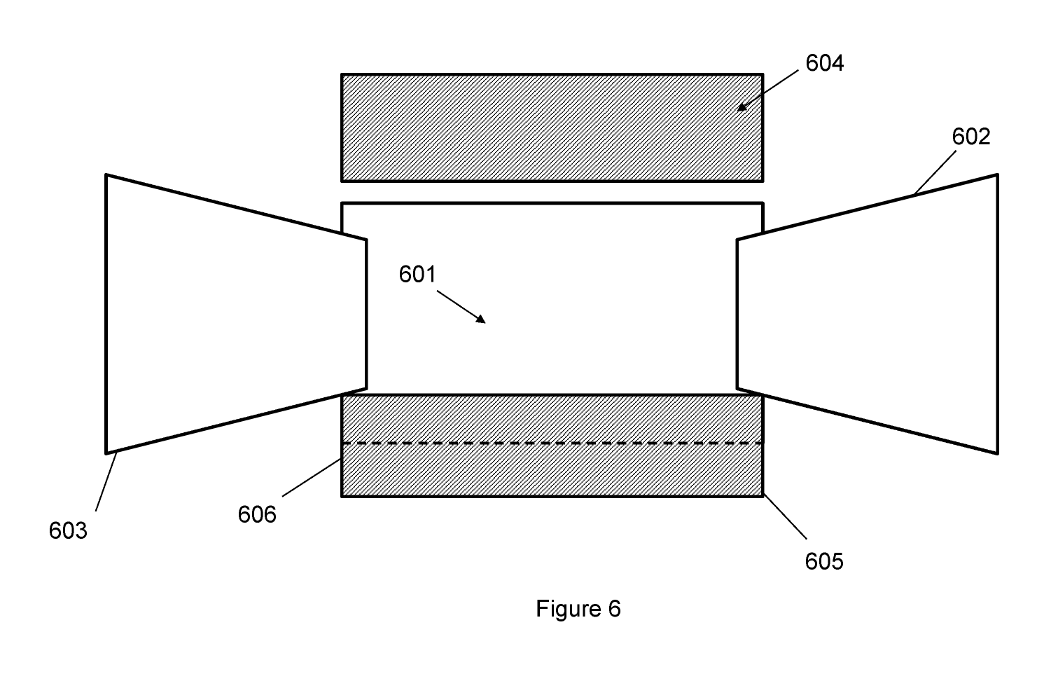

In the extended (e.g., open) position, bracket 300 allows a screen to be positioned a distance away from base 308. In some cases, the extended position places frame 304 closer to the audience. FIG. 5 is a top plan view of the screen mounting bracket of FIG. 4 when it is in an extended position, joint 302 has been advanced along arm 305 in a forward direction, causing lever arm 303 to advance at least the upper forward edge of left side screen 401 in a medial direction, closer to the audience. In some cases, advancing the forward edge of left side screen 401 medially to the limit of travel may cause some overlap between the upper portion of left side screen 401 and front screen 400, which may be the main-viewing screen. In an extended position, bracket 300 is extended such that left side screen 401 is positioned farther out, closer to the audience. Also, in some cases, positioning screen 401 in the extended position may cause some overlap between left side screen 401 and front screen 400.

The lateral screens and the central screen may have different heights.

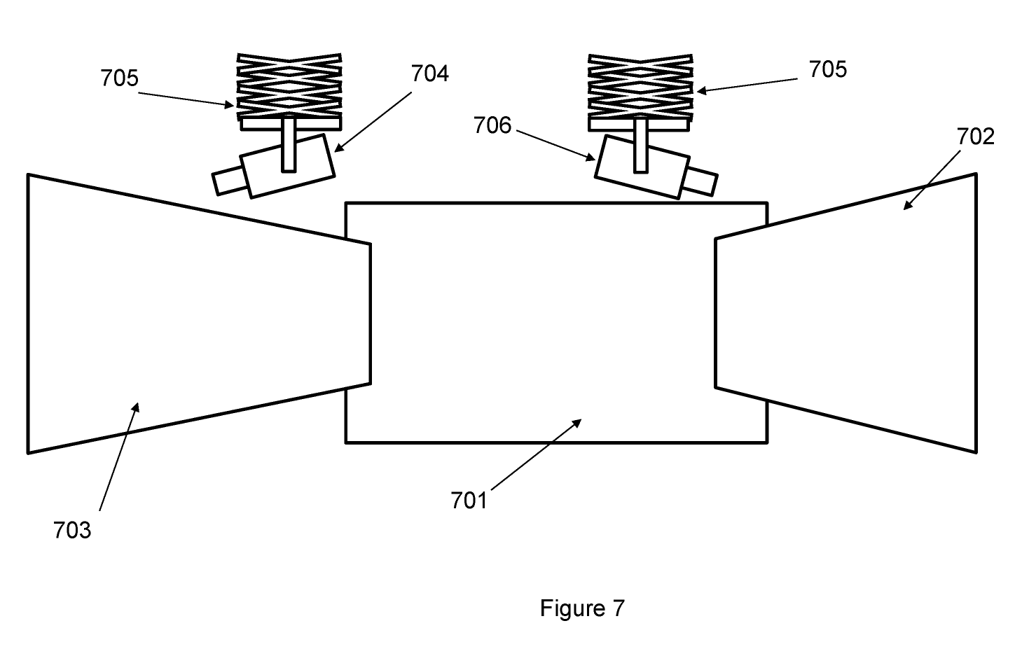

In that case, it may be preferable to mask part of the central screen both in its upper and lower portions. Masking is illustrated on FIG. 6. The lateral screens 602 and 603 are shown in their extended position partially overlapping the central screen 601. The upper mask 604 is shown in its retracted position, away from the main screen 601, while the lower mask 605 is shown in its nominal position to mask part of the lower main screen 601. The dashed line 606 indicates the lower limit of the central screen 601, hidden by mask 605.

For a normal projection, i.e. a projection on a single central screen 601, mask 604 and mask 605 do not overlap the screen 601.

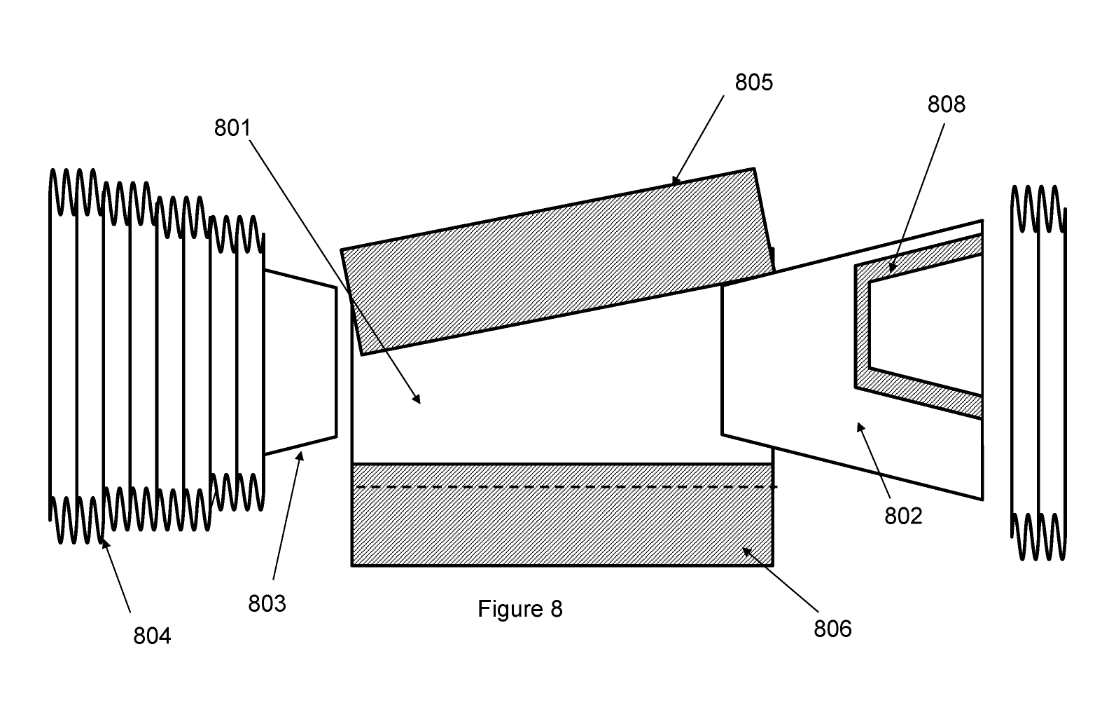

The projectors 704 and 706 that project images on the lateral screens can be attached to the ceiling by means of e.g. scissor mounts 705 and 707 as illustrated on FIG. 7.

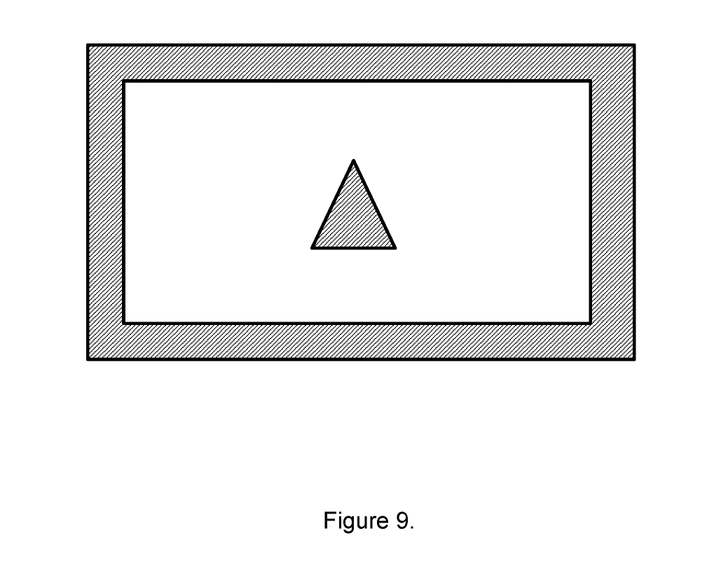

FIG. 8 shows a display set-up for which several problems arose.

Lateral screen 803 did not deploy properly and does not overlap the main screen 801. Curtain 804 did not open properly and obscures at least part of the lateral screen 803.

Upper and lower masks 805 and 806 were not positioned properly. This can be the case if a problem occurs with the deployment mechanism e.g. a motor that failed, as is illustrated on FIG. 8 for the lower mask (that did not reach its nominal position), or a cable that broke as illustrated on FIG. 8 for the upper mask.

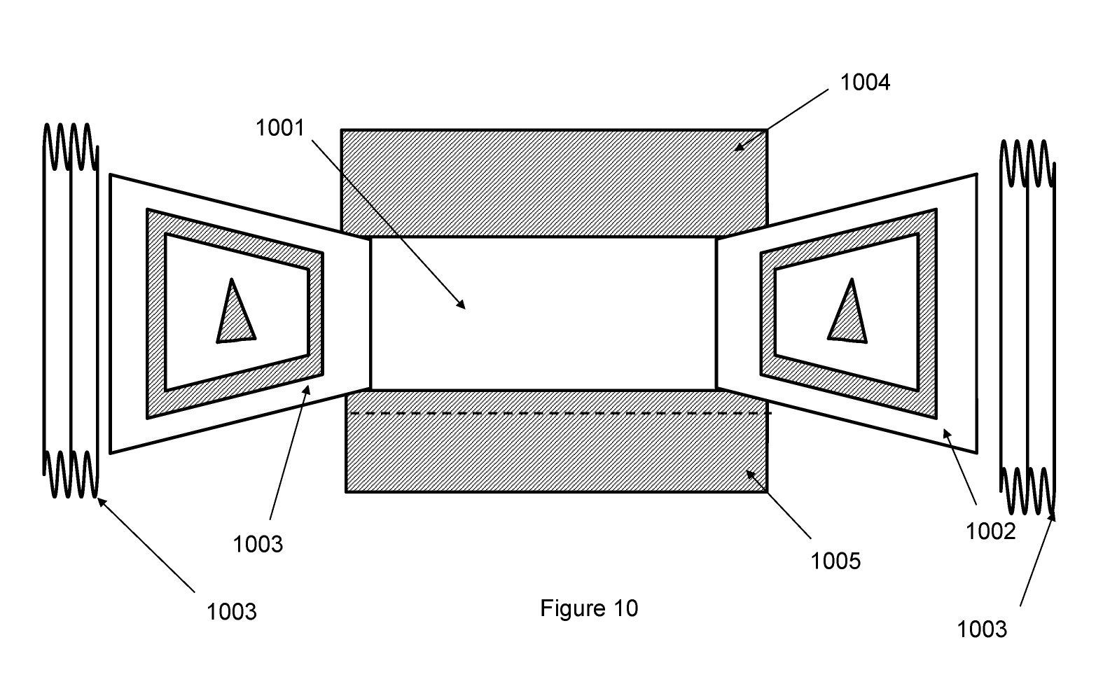

In the example of FIG. 8, projector 807 that projects images on screen 802 did not deploy properly. Projector 807 is not shown on FIG. 8. The image 808 projected by projector 807 on screen 802 can be e.g. an image like that of FIG. 9. In case of a failure of the deployment mechanism of projector 807, the image 808 projected on screen 802 will not be aligned properly as has been illustrated on FIG. 8. In the example of FIG. 8, two sides of the rectangle projected on screen 802 are missing because of an improper positioning of the projector 807. In some cases, it is sufficient to project a white field on the side screens. Indeed, if there is an alignment problem, some parts of the screen will not be lit by the projector and will generate large differences in pixel values between the first picture and the second picture.

If the main projector (not shown), projecting on the main screen is improperly aligned, projecting a pattern on the main screen 801 can help detect e.g. an alignment error. The absence of projected pattern can indicate a failure of the main projector (e.g. the light engine being defective). In a simple case, there is no need for a pattern. Projecting a white filed can be sufficient to detect an alignment problem (parts of the screen not lit by the projector will be darker that parts of the screen lit by the projector).

The inventors realized that failures of the immersive display system, examples of which have been described here above, can be detected by taking at least two images or pictures of the entire set-up. Alternatively one of the images or pictures can be generated digitally and is representative of the display system.

An image capturing device is preferably positioned close to the projector projecting images on the main screen. The image capturing device has a field of view encompassing all the regions of the display system where it can be possible to detect failure.

An image capturing device is for instance a digital camera associated with a data storage and data processing system like e.g. a computer.

The image capturing device and data processing and data storage system can be integrated into a projector of the display system. In particular, the image capturing device can be integrated with the main projector that projects images on the central screen 101 of an Escape™ display system.

The first image captured by the image capturing device can be stored on a hard disk, a CD or DVD-ROM or any other convenient media to store digital image data. Alternatively the first image is a digital image generated by computer based on e.g. a 3D model of the display system.

The first of the at least two images or pictures can be taken under supervision of a technician. The first image or picture is taken when the display system is operating nominally. For instance, the curtains have been withdrawn and do not overlap the lateral screens; the lateral screens have been deployed properly and overlap the main screen; the upper and/or lower masks have been deployed properly and respectively overlap an upper or lower portion of the main screen; the projectors projecting images on the lateral screens have been deployed properly and test images projected on the lateral screens are aligned with the lateral screens. The first picture is a reference picture containing information concerning a display system operating according to expectations.

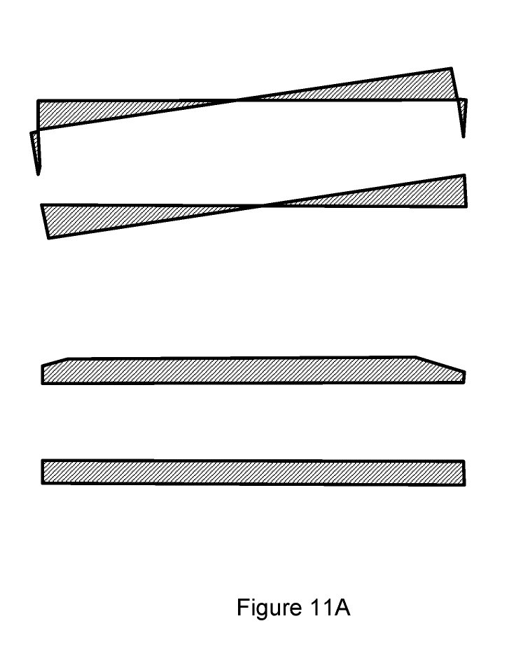

An example of first picture of the display system operating nominally is given on FIG. 10.

The lateral screens 1002 and 1003 have been deployed properly and overlap the central screen 1001. Curtains 1004 and 1007 have been withdrawn correctly and do not cover (any part of) the lateral screens. Masks 1005 and 1006 are in their correct position and overlap the top and the bottom of the central screen. Images (e.g. like the image of FIG. 9) are projected at the right position on the lateral screens. Note that it may be sufficient to project a white field to test the alignment and the light engine of a projector. Indeed, if the light engine fails, the amount of light reaching the screen will be less than nominal; this will be detected as a difference in pixel value when a picture of the display system in operation is compared with a reference picture of the display system operating nominally. If the projector is not properly aligned, some parts of the screen will be darker than others. This will also be detected as a difference in pixel value when a picture of the display system in operation is compared with a reference picture of the display system operating nominally.

The first picture can be taken on site, with the display system to be monitored. Alternatively, the first picture can be taken off-site with a display system similar or identical to the display system that will be monitored. Alternatively, the first picture can be generated digitally (e.g. based on a 3D model generated by a 3D modeling software like SketchUp).

Let us now consider the same display system at a later time where one or more failures have occurred like on the examples of FIG. 8.

All other things being kept equal (lighting conditions in the projection room, position of the camera used to take the picture as well as camera settings), a second image or picture is taken.

The lighting conditions can be checked with e.g. a photometer (for example, distinct from the image capturing device). If the lighting conditions have varied too much, the pixel values of the second image can be modified to compensate for the different lighting conditions in order to facilitate comparison of the first and the second images or pictures.

Alternatively, the photometer can be used to determine when it is most advantageous to take the second picture. Indeed, the content of the images being projected can influence the lighting conditions. When the photometer indicates that the lighting conditions are comparable to the lighting conditions in which the first picture was taken, the image capturing device can be triggered and a second image or picture of the display system can be taken.

Both the first and second images or pictures are preferably encoded using the same format. The format can for instance be a bmp, a png or a jpeg file.

The second image or picture is compared with the first picture. Discrepancies between the two images or pictures indicate one or more system failure.

Comparison of the two images or pictures can be e.g. a pixel by pixel subtraction. For each pixel of the first image or picture and the corresponding pixel of the second image or picture, the pixel value of the second image or picture is subtracted from the pixel value of the first image or picture. The result is a third image encoding the differences between the first image or picture and the second image or picture.

If both images or pictures are identical, the resulting third image or picture is black. In such a case the amplitude of each pixel would be zero. Slight variations can exist in the lighting conditions of the projection room between the time the first and second images or pictures were taken. This will result in a third picture for which at least some of the pixels are not black. If the conditions are close enough and in absence of failure, the amplitude of the pixels in the third image picture will be close to zero.

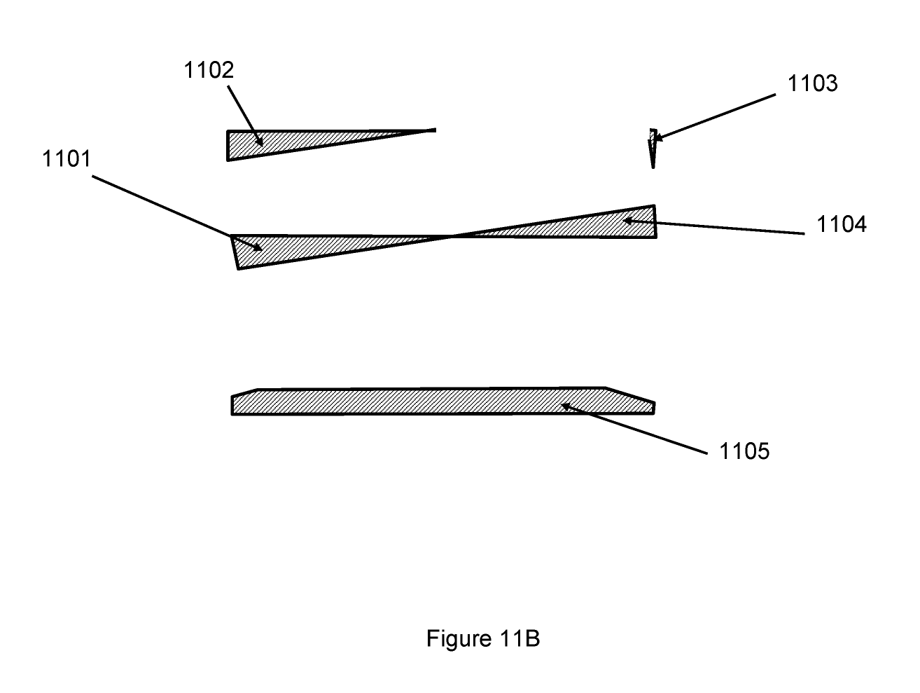

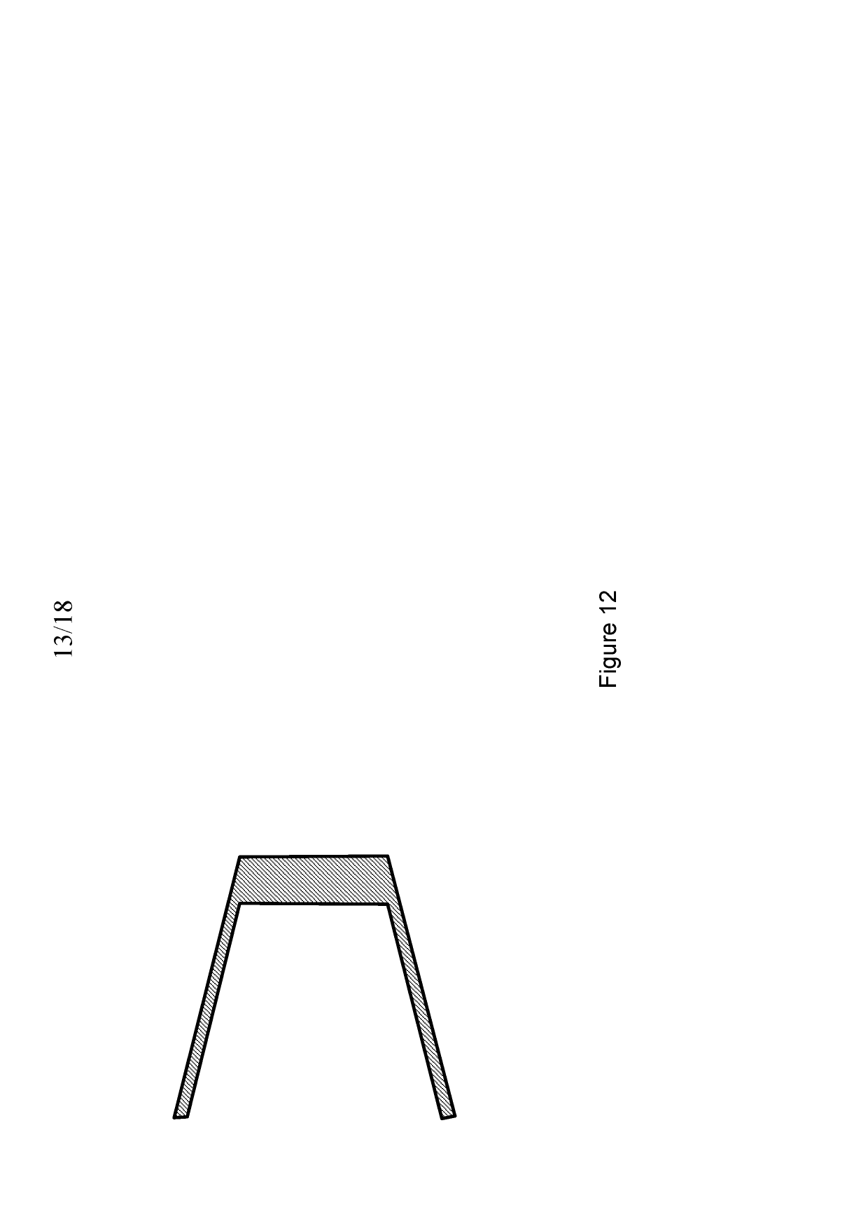

FIG. 11A shows the result of a subtraction between a first image or picture (corresponding to FIG. 10) and a second image or picture (corresponding to a failure of the upper and lower masks as seen on FIG. 8). The result of the subtraction is taken in absolute values. The zones highlighted on FIG. 11 shows the region where the major differences are expected.

FIG. 11B shows the result of a thresholding operation: any pixel intensity lower than a given threshold is set to zero. FIG. 11B shows the zones 1101, 1102, 1103, 1104 and 1105 with the largest differences between the first and the second images or pictures.

The masks being dark and the walls behind the projection screen being darker than the screen as well (i.e. they reflect a lot less light than the central screen they overlap), the largest difference between the first and the second images or pictures (of a system with masking failure) will happen in (a) the zones of the central screen that are actually masked but that nominally should not be masked and (b) the zones of the central screen that are actually not masked but that should be masked if no failure had occurred.

The difference between the first and second images or pictures is expected to increase with higher lumen output of the main projector. Although it is not excluded from the scope of the present invention, no dedicated test pattern need be projected on the main screen to detect failure of the masks.

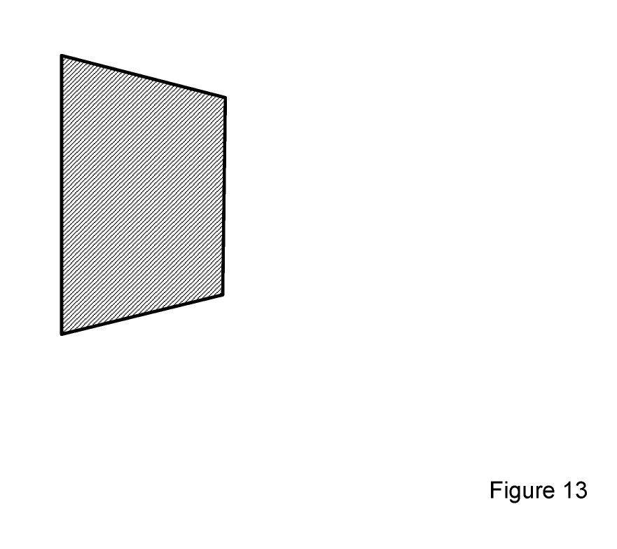

FIG. 12 shows the result of a subtraction between a first image or picture (corresponding to FIG. 10) and a second image or picture (corresponding to a failure of deployment system for the lateral screen 1003 on FIG. 10). The result of the subtraction is taken in absolute values. The zones highlighted on FIG. 12 shows the region where the major differences can be found after a thresholding operation

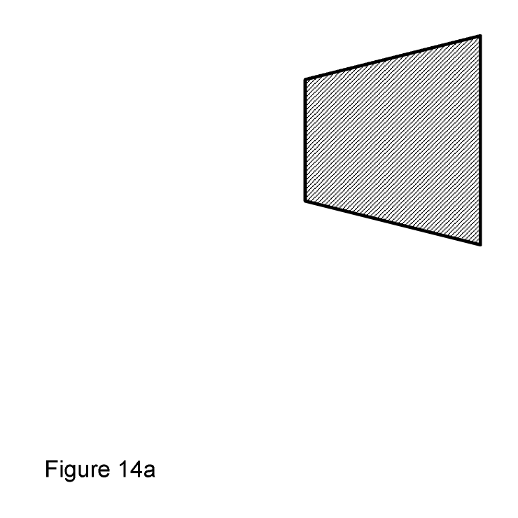

FIG. 13 shows the result of a subtraction between a first image or picture (corresponding to figure the display system of FIG. 10) and a second image or picture (corresponding to a failure of the curtain withdrawal system). The result of the subtraction is taken in absolute values. The zones highlighted on FIG. 13 shows the region where the major differences can be found after a thresholding operation.

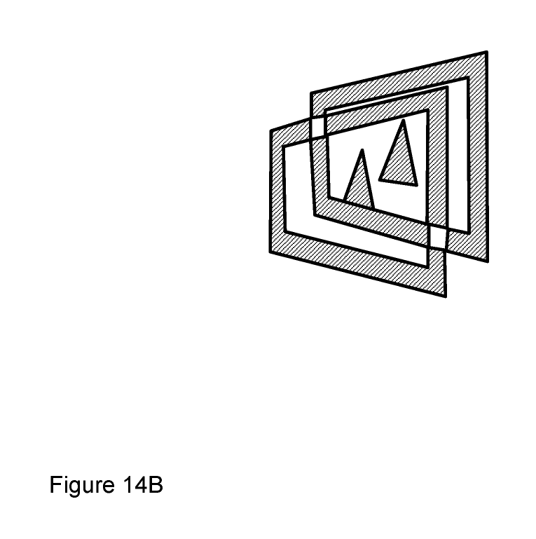

FIG. 14A shows the result of a subtraction between a first image or picture (corresponding to the display system of FIG. 10) and a second image or picture (corresponding to a failure of the deployment system for the projector projecting images on the lateral screen 1002). The result of the subtraction is taken in absolute values. The zones highlighted on FIG. 14A shows the region where the major differences can be found after a thresholding operation. For FIG. 14A, the projector projects a white field (i.e. no particular pattern is projected). For FIG. 14B, the projector projects an image like the image of FIG. 9.

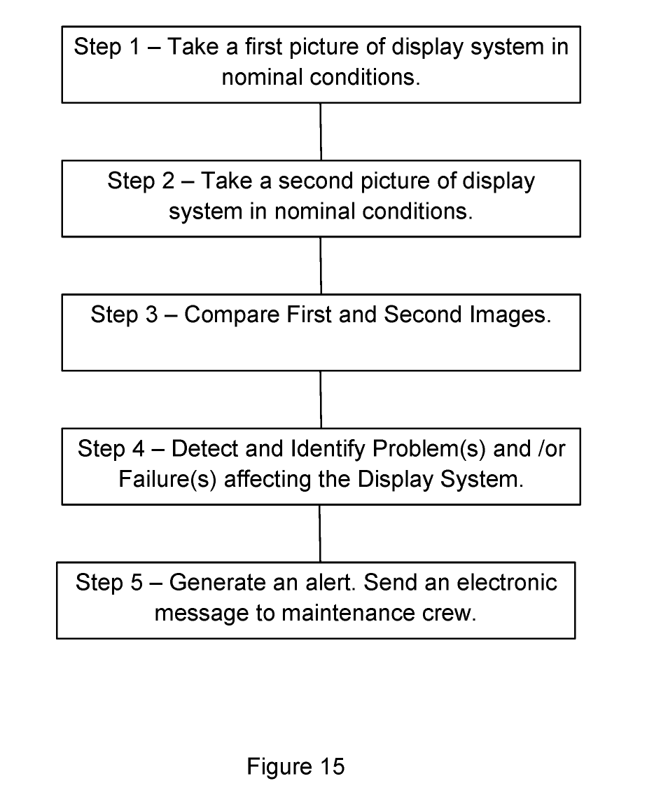

An overview of the method according to an embodiment of the present invention is given on FIG. 15.

In a first step, a first image or picture of the display system is generated; the first image or picture is a reference picture representative of the display system when it is operating nominally. The first image or picture can be captured by an image capturing device or it can be generated on the base of a 3D model of the display system.

In a second step, a second image or picture of the display system is taken at an later moment in time. An example of moment to take the second image or picture is right before the theatrical projection begins, when e.g. the curtains have been withdrawn from lateral screens, when the lateral screens have been deployed and the masks have been positioned.

In a third step, the first and second images or pictures are compared. The result of the comparison is used to detect and identify problems or failures with the display system.

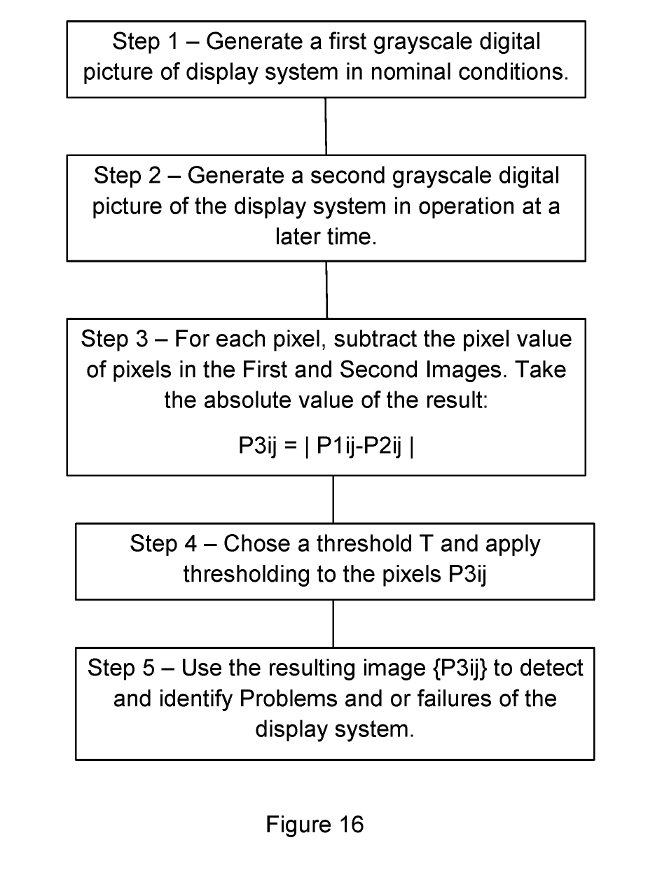

An overview of a particular case of the method according to an embodiment of the present invention is given on FIG. 16.

In a first step, a first grayscale digital picture of the display system in nominal conditions is generated. The picture corresponds for instance to the display system as illustrated in FIG. 10. The lateral screens are properly deployed and are in their nominal positions. An upper and/or a lower mask have been positioned over an upper and/or a lower part of the main screen, curtains have been drawn away from the lateral screens and the projectors projecting images on the lateral screens have been deployed properly.

The first image is stored for future use.

In a second step, a second grayscale digital picture of the display system in operation is taken. The second picture is taken with the same camera. The second picture can be taken when the lighting conditions in which the display system is operated are similar to the lighting conditions when the first picture of the display system was taken. This can be confirmed by a means to capture lighting conditions such as a photometer.

In a third step, for each pixel, the pixel value of pixels in the second image are subtracted from the pixel value in the first image. The absolute value of the result is taken.

If i and j are the coordinates of a pixel in the first and second images, then we have

P3ij=|P1ij−P2ij| where P1ij and P2 ij are the pixel values at position of a pixel in the first picture n

Step 4—Chose a threshold T and apply thresholding to the pixels P3ij

Step 5—Use the resulting image {P3ij} to detect and identify problems and or failures of the display system. Artificial intelligence or machine learning methods can be used to automate and objectify the identification process.

The same method can be applied to detect failure in the display system when it is configured for projection on the main screen only lateral screens moved away from the main screen and covered by curtains.

In an alternative of the method, a reference image or picture is taken for each different stage of the deployment of the display system.

In normal use, the deployment of an Escape™ display system can be done in well-defined steps. As an example, let us says that an Escape™ display system is deployed as follows:
Step A: first the curtains are withdrawn from the lateral screens.
Step B: then the lateral screens are moved from their first position away from the central screen into their second position overlapping the central screen,
Step C: When the lateral screen are assumed to be in position, the masks are positioned to cover parts of the central screen,
Step D: Finally, the one or more projectors projecting images on the lateral screens are deployed.

A first reference picture, let us designate it as Reference Picture A, has been generated earlier that is representative of the Escape™ system when the curtains have been properly withdrawn.

During the deployment of the Escape™ display systems, a second picture A is taken of the display system between Step A and Step B.

Reference Picture A is compared with Second Picture A and a failure of the curtains withdrawal system can be detected based on the appearance of the display system between Step A and Step B. If a failure is detected, an alarm can be generated to signal a problem with the curtains.

At the end of Step B and before Step C, a second picture B is taken of the display system.

A second reference picture, let us designate it as Reference Picture B, has been generated earlier that is representative of the Escape™ system when the curtains have been withdrawn and the lateral screens have reached their second position overlapping the central screen.

A second picture B of the display system is taken between Step B and Step C.

Reference Picture B is compared with Second Picture B and a failure of the lateral screen positioning system can be detected based on the appearance of the display system between Step B and Step C. If a failure is detected, an alarm can be generated to signal a problem with the deployment of the lateral screens.

A third reference picture, let us designate it as Reference Picture C, has been generated earlier that is representative of the escape system when the masks have been positioned correctly over an upper part and a lower part of the central screen (the curtains have been withdrawn properly and the lateral screens have been deployed in the nominal second position).

A second picture C of the display system is taken between Step C and Step D.

Reference Picture C is compared with Second Picture C and a failure of the masks positioning system can be detected based on the appearance of the display system between Step C and

Step D. If a failure is detected, an alarm can be generated to signal a problem with the positioning of the masks.

A fourth reference picture, let us designate it as Reference Picture D, has been generated earlier that is representative of the escape system when the projectors projecting images on the lateral screen have been deployed and project e.g. a white field on the lateral screens (the curtains have been withdrawn properly and the lateral screens have been deployed in the nominal second position and the masks have been positioned in their nominal position as well).

A second picture D of the display system is taken between after Step D.

Reference Picture D is compared with Second Picture D and a failure of the projector deployment system can be detected based on the appearance of the display system after Step D. If a failure is detected, an alarm can be generated to signal a problem with the deployment of the projectors.

An embodiment of the present invention of a method t can be implemented by a digital device with processing capability including one or more microprocessors, processors, microcontrollers, or central processing units (CPU) and/or a Graphics Processing Units (GPU) adapted to carry out the respective functions programmed with software, i.e. one or more computer programs. The software can be compiled to run on any of the microprocessors, processors, microcontrollers, or central processing units (CPU) and/or a Graphics Processing Units (GPU).

Such a device may be a standalone device or may be embedded in another electronic component. The device may have memory (such as non-transitory computer readable medium, RAM and/or ROM), an operating system, optionally a display such as a fixed format display such as an OLED display, data entry devices such as a keyboard, a pointer device such as a “mouse”, serial or parallel ports to communicate with other devices, network cards and connections to connect to a network.

The software can be embodied in a computer program product adapted to carry out the following functions when the software is loaded onto the respective device or devices or any other device such as a network device of which a server is one example and executed on one or more processing engines such as microprocessors, ASIC's, FPGA,'s etc.:

monitoring operation of a display system;

triggering generation of a first image or picture of the display system that is representative of the system when it is operating nominally;

triggering generation of a second image or picture of the display system;

comparing the first and second images or pictures;

evaluating differences between first and second images or pictures to detect problems or failures of the display system.

The software can be embodied in a computer program product adapted to carry out the following functions when the software is loaded onto the respective device or devices or any other device such as a network device of which a server is one example and executed on one or more processing engines such as microprocessors, ASIC's, FPGA's, etc.:

generation of an alarm when a problem or failure has been detected,

generation of the first image or picture based on a 3D model of the display system,

subtracting the pixel values in the second image or picture from the pixel values in the first image or picture.

applying a thresholding operation.

evaluating the lighting conditions to modify the second picture before comparing it with the first picture,

detecting problems and/or failures of the display system with artificial intelligence or machine learning.

Any of the software mentioned above may be stored on a non-transitory signal storage means such as an optical disk (CD-ROM, DVD-ROM), magnetic tape, solid state memory such as a flash drive, magnetic disk such as a computer hard drive or similar.

1. A method to monitor operation of a display system where in a first step a first picture of the display system is generated that is representative of the system when it is operating nominally; in a second step a second picture of the display system is taken; in a third step, the first and second pictures are compared and differences between first and second pictures are evaluated to detect problems or failures of the display system.

2. The method according to claim 1 wherein in a fourth step an alarm is generated when a problem or failure has been detected in the third step.

3. The method according to claim 1, wherein the first picture is generated based on a 3D model of the display system.

4. The method according to claim 1, wherein the third step involves subtracting the pixel values in the second picture from the pixel values in the first picture.

5. The method according to claim 1, wherein the third step involves a thresholding operation.

6. The method according to claim 1, wherein the lighting conditions are evaluated.

7. The method according to claim 1, wherein the evaluation of the lighting conditions determines when to initiate the second step.

8. The method according to claim 1, wherein the evaluation of the lighting conditions is used to modify the second picture before comparing it with the first picture.

9. An apparatus to detect failures in a display system, the apparatus comprising an image capturing device to capture at least one picture of the multi-screen display system, a data storage to store the at least one picture of the display system and data processing means to compare the at least one picture with at least one reference picture and detect problems and/or failures of the display system.

10. The apparatus according to claim 9, further comprising means for evaluating light conditions when a picture of the display system is taken.

11. The apparatus according to claim 10, wherein the means for evaluating light conditions is a photometer.

12. The apparatus according to claim 10, wherein the image capturing device and/or the means to evaluate the lighting conditions is an integral part of a projector projecting images on at least one screen of the display system.

13. The apparatus according to claim 9, wherein the data processing means comprises artificial intelligence or machine learning to detect problems and/or failures of the display system.

14. A computer program product for executing the method steps of claim 1 when executed on a processor.

15. A non-transitory signal storage medium storing the computer program product of claim 14.
